(19) United States
(12) Patent Application Publication
(10) Pub. No.: US 2012/0134595 A1
(43) Pub. Date: May 31, 2012

(54) METHOD AND APPARATUS FOR PROVIDING AN IMAGE FOR DISPLAY

(75) Inventors: Pedro Fonseca, Eindhoven (NL); Marc Andre Peters, Eindhoven (NL)

(73) Assignee: KONINKLIJKE PHILIPS ELECTRONICS N.V., EINDHOVEN (NL)

(21) Appl. No.: 13/389,012

(22) PCT Filed: Aug. 11, 2010
(86) PCT No.: PCT/IB10/53625

§ 371 Date: Feb. 6, 2012

(30) Foreign Application Priority Data
Aug. 11, 2009 (EP) 09167596.7

(51) Int. Cl. G06K 9/46; G06K 9/32

(52) U.S. Cl. 382/195; 382/298

(57) ABSTRACT

At least one region of interest within an image is determined, step 201. The image is resized to a target image size step 207. If at least one region of interest is determined the image is cropped to each of the at least one region of interest, step 205 and the cropped at least one region of interest is resized to the target image size. The re-sized image and the resized cropped at least one region of interest are stored for display, step 209.

### FIELD OF THE INVENTION

The present invention relates method and apparatus for providing an image for display. In particular, it relates to resizing an image to a target image size for display.

### BACKGROUND TO THE INVENTION

Recent years have seen an explosion in the amount of digital images users capture daily.

While in the past users captured only images during special events and were careful about the composition of the images, since it was costly to have these developed, digital photo cameras and increasing storage space have led to a drastic change in behaviour. It is now typical that users capture multiple images of the same subject, and not uncommon that they return home from holidays with hundreds, or even thousands of images.

The resolution of these images and, correspondingly, the physical size they occupy on storage devices, has also increased significantly; however, the storage space of preferential devices used to display these images (e.g. digital photo frames) is limited. Furthermore, users often use bandwidth-limited means to share specific photos with their family and friends, or simply post them on Internet blogs or social websites. Therefore, there is a desire to reduce the physical size these images occupy on storage devices.

This has been partly overcome by automatically resizing the images that are uploaded to their internal memory. This resizing process has the advantages of both optimizing the image size according to a target image size, for example the display size of the photo frame and of utilising less storage space on the device, thus allowing more images to be stored. This resizing step could be done just before displaying each image, i.e., the image could be stored with its full resolution and resized to fit the target image size each time just before it would be rendered; however, this would have the consequence that less images could be stored on the device and of utilising additional computational resources repeating the same process for each image displayed.

While this automatic resize step is advantageous for these two aspects, it has the disadvantage that if the user wants to “zoom in” on interesting elements of the image—for example, faces—the quality of those areas will be very low, since the image was previously downsized. If instead the “zoom in” would be done on the original image, the quality would typically be vastly superior. Since faces are often the most important elements in the photos captured by users, it is fundamental that their quality is kept to the maximum possible when displayed.

Furthermore, since the display size is relatively small and these frames are typically positioned on the top of a table or closet, or simply hung on a wall, they are rather far away from the user's view. Furthermore, only certain parts of most images are interesting to show, for example faces of family, friends or loved ones. When displayed far away, these interesting regions are too small to be appreciated when displayed on these devices. Face detection is a known technique to determine areas in an image that contains a face. Therefore face detection has been used to automatically determine a region in an image containing face(s) such that the most interesting parts of such images can be resized and occupy as much display size as possible.

Face detection gives good results for the areas in an image that contain the main features of a face. This is area determined by the eyes, nose and mouth. Parts like the hair are not characteristic since they differ too much between humans.

One known technique is to use the results of a face detector to simply crop the image to the area returned by the detector. This results in providing exactly the part of the image that contains the main features of the face. However, this is hardly attractive, as it fails to show the entire face as well as the necessary elements of the context surrounding the face, needed to give a pleasant viewing experience.

WO 2008/025969, for example, discloses a variety of techniques for cropping and resizing an image such that interesting elements of the image are cropped and the interesting element, such as a face, is resized. However, the techniques do not maintain the aspect ratio of the original image and thus distortion of the face occurs which is particularly undesirable for a face. Further, the user is not given the option of displaying the original image or displaying the interesting element.

### SUMMARY OF INVENTION

The present invention seeks to provide an image (or parts of an image) for display in which maximum quality is guaranteed whilst minimising the storage requirements.

This is achieved, according to one aspect of the present invention, by a method for providing an image for display, the method comprising the steps of: determining at least one region of interest within an image; resizing the image to a target image size; if a region of interest is determined, cropping the image to each of the at least one region of interest; resizing the cropped at least one region of interest to the target image size; storing the resized image and the resized cropped at least one region of interest for display.

This is also achieved, according to a second aspect of the present invention, by apparatus for providing an image for display, the apparatus comprising: determining means for determining at least one region of interest within an image; a processor for resizing the image to a target image size and, if at least one region of interest is determined, cropping the image to each of the at least one region of interest and resizing the cropped at least one region of interest to the target image size; storage means for storing the resized image and the resized cropped at least one region of interest for display.

In this way, both the resized image and the resized region of interest are stored for display. As the region of interest is resized from the original image, the quality of the images is maintained whilst reducing storage requirements and enabling either the resized image or the resized region of interest to be displayed. By linking these two images together, it becomes easy to allow a user to choose one of the two stored images.

In an embodiment, the step of resizing the image to a target image size comprises the steps of: determining the size and aspect ratio of the target image; determining the size and aspect ratio of the image; determining a scaling factor from the determined size of the target image and the determined size of the image; and resizing the image according to the determined scaling factor. Further, the step of resizing the cropped at least one region of interest to the target image size may comprise the steps of: determining the size and aspect ratio of the cropped at least one region of interest; determining a scaling factor from the determined size of the target image and the determined size of the cropped at least one region of interest; and resizing the cropped at least one region of interest according to the determined scaling factor whilst maintaining the determined aspect ratio of the cropped at least one region of interest. Further, the step of resizing the cropped at least one region of interest according to the determined scaling factor whilst maintaining the determined aspect ratio may comprise the steps of: extending the cropped at least one region of interest to include at least a portion of the image outside of the cropped at least one region of interest such that the extended at least one region of interest has an aspect ratio corresponding to the determined aspect ratio of the image; cropping the image to the extended at least one region of interest; and resizing the cropped extended at least one region of interest to the target image size.

In this way, the aspect ratio of both the image and the at least one region of interest are maintained when resizing which eliminates distortion of the image.

In an embodiment, the step of determining at least one region of interest within an image comprises the step of: automatically detecting at least one region of interest within an image and the step of cropping the image to each of the at least one region of interest comprises the steps of: extending the detected at least one region of interest to include a portion of the image outside of the detected at least one region of interest; cropping the image to the extended at least one region of interest. Alternatively, the at least one region of interest within an image may be determined by manually defining at least one region of interest within an image.

If the at least one region of interest is automatically detected by for example a face detector, the at least one region of interest can be extended to include the entire face as well as elements of context surrounding the face improving the viewing experience.

This may be achieved by automatically detecting, during upload of images to devices (e.g. photo frames), which are the interesting elements in those images and therefore, those that the user would likely appreciate to see “zoomed in”. If these elements are detected, then two copies of the photo are stored: a) resized to fit the display size and b), where the original image is cropped to the location of the interesting region and then downsized to fit the display size. As an alternative embodiment, the selection of the interesting regions of the original image can be chosen manually, by the user.

While displaying the image, if the user wants to watch the entire image, then the first one (a) is chosen for display; if instead the user prefers to watch the interesting elements only, then the second image (b) is chosen for display.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for providing an image for display according to an embodiment of the present invention;

FIG. 2 is a flowchart of a method of for providing an image for display according to an embodiment of the present invention; and

FIG. 3 is a simplified schematic of the storage means of the apparatus of FIG. 1.

### DETAILED DESCRIPTION OF EMBODIMENTS OF THE INVENTION

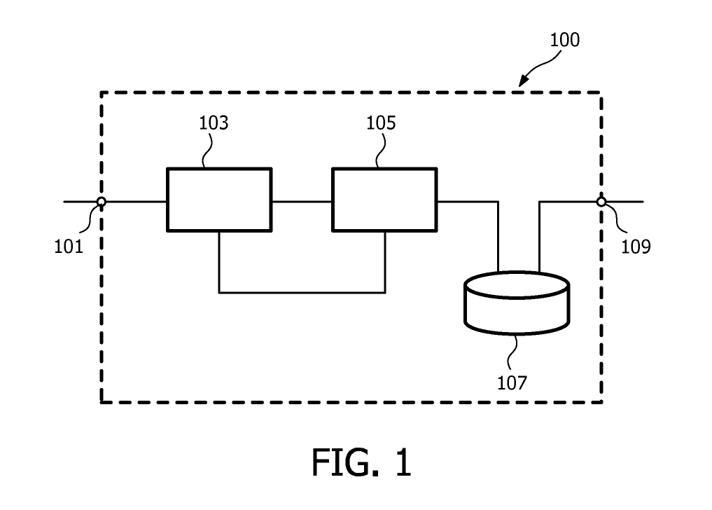

With reference to FIG. 1, the apparatus 100 of an embodiment comprises an input terminal 101 connected to the input of a determining means 103. The output of the determining means 103 is connected to an input of a processor 105. The input terminal 101 is also connected to an input of the processor 105. The output of the processor 105 is connected to a storage means 107. The storage means 107 is connected to an output terminal 109 of the apparatus 100.

Although the storage means 107 is illustrated here as internal to the apparatus 100, in an alternative embodiment, the storage means 107 may be external to the apparatus. The storage means 107 may be a memory device of a computer system, such as a ROM/RAM drive, CD, a memory device of a camera, digital photo frame or like device connected to the apparatus 100, or remote server. It may be accessed via a wired or wireless connection and/or accessed via a wider network such as the Internet. The storage means 107 stores a plurality of images to display. Images stored on a remote server, for example, may be uploaded and temporarily stored in the storage means 107 of the apparatus 100.

The output terminal is connected to display for rendering the images of the storage means 107. The display may be an integral part of the apparatus 100 (not shown here).

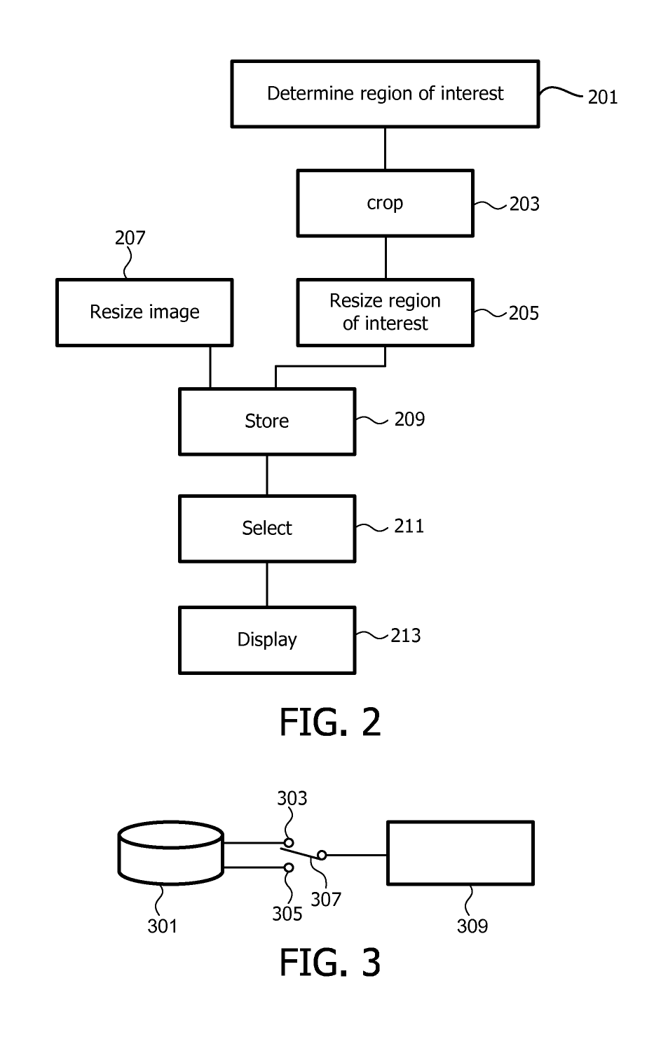

Operation of the apparatus of FIG. 1 will now be described with reference to FIG. 2.

An image is retrieved from an external storage means (not shown here) and input via the input terminal 101 into the determining means 103. The image is resized, step 207, to a target image size, for example the image may be resized to fit a display by the processor 105. Invariably the image is downsized, since the resolution of the image is typically much larger than that of the display of a photo frame. The resized image is stored, step 209, in the storage means 107 as currently occurs in conventional photo frame devices.

In parallel, at least one region of interest of the image is determined, step 201, by the determining means 103. The determining means 103 may include a detector for automatically detecting, for example, the location of one or multiple faces using existing state-of-the-art face detection algorithms or alternatively, the user can manually specify the region of interest of the image. The original image is then cropped, step 203, to that region and the resulting image is then resized, step 205, to the target image size to fit the display of the photo frame (for example) by the processor 105.

This resize step 205 may be optional and may depend on the result of the cropping, step 203, if the resulting cropped image fits exactly the dimensions of the photo frame, no resizing is needed. Otherwise, if the cropped image is smaller than the resolution of the photo frame display, the image is upsized; if the cropped image is still larger than the resolution of the photo frame display, the image is downsized.

After this step, the cropped/resized region of interest of the image is stored, step 209, in the storage means 107.

When displaying an image, the choice of which image to take depends on the display options. With reference to FIG. 3, if the user wishes to see the entire image then the downsized image is used. This is achieved by the selector 307 connecting to a first output terminal 303 of the storage means 301 (storage means 107 of FIG. 1) and selecting the entire image (step 211) to display the entire image on the display 309 (step 213). Alternatively, if the user wishes to see only the region of interest, then the cropped/resized image is used instead. This is achieved by the selector 307 connecting to a second output terminal 305 of the storage means 301 and selecting the cropped/resized region of interest of the image (step 211) to display the region of interest on the display 309 (step 213).

Although the method described above is applied in digital photo frames, it can be appreciated that the same method could be applied on Internet photo sharing services, email services where photos are attached, etc.

In automatically detecting a region of interest and hence determining an appropriate cropping area, several items are of importance.

The first item which is taken into consideration is minimum size. After cropping a face based on the resolution of the target application, the face can still be downscaled to actually fit the dimensions. So, a minimum size for the faces is imposed, it is guaranteed that the face is either large enough to be clear when displayed in the photo frame, or that it can be downscaled to be so. For example consider faces that are at least a quarter of the smaller side of the frame. If the frame has a resolution of 800×600, the face width/height is to be at least 150.

A second item which is taken into consideration is region extension. Where the facial features include eyes, nose and mouth, the area is extended significantly in order to guarantee that the whole face, plus a bit of the surrounding context is included. For example all four sides surrounding the face can be extended. For example, if the facial features cover an area of 300×300, the region of interest would be 900×900, created by extending each of the four sides by 300 pixels. However, if, for example, the face is located at the edge of the image, the extension is made at the other side of the faces so that the extension is not made outside of the image.

A third item which is taken into consideration is resolution of the target display. For example if the target display is a digital photo frame, the resolution of the photo frame is determined. The region of interest should be extended to match the ratio of the resolution of the photo frame. Continuing the previous example where the region of interest is 900×900 and the photo frame is 800×600. The photo frame ratio is 800/600=4/3. So the region of interest should be extended to 1200×900 such that the ratio is the same. After cropping the original image to this 1200×900 pixel region, this area can be downscaled to match the photo frame resolution.

A fourth item which is taken into consideration is orientation of the target display. Since a photo frame can be displayed in either landscape or portrait styles, it is advised to take both into account and prepare 2 regions that can be used by the application.

Face location is also taken into account. Often the face is centered in the image; however there are plenty of occasions where the user chooses to have the face outside the centre. In determining the final extension of the face region this can be taken into account, which means that the face will be located slightly off centre as well, either in left/right or top/bottom direction. In the example before there was a 900×900 region that had to be extended to 1200×900. The straightforward choice would be to extend both left and right by 150 pixels. However, if the face is not centered, one side is extended with 300 pixels and the other side is left as it is.

If the image contains multiple faces and a region is computed for each face, the region of interest could be moved to avoid overlap with another face. If possible, part of another face at the edge of the region of interest is avoided. However, this is not always possible. As in the example above, where the 900×900 region has to be extended to 1200×900. The region of interest can be shifted slightly left and right to avoid this kind of overlap. However if another face is partly located within the original 900×900 region, this cannot be avoided without running the risk of cutting for example part of the hair region.

If the image contains multiple faces, the image could be cropped and resized to an area containing all the faces together rather than cropping each face separately. Now the region containing the faces becomes a rectangle enclosing the regions of all the faces. This can be extended by determining the extension that each face separately and then take the maximum of those extensions. This guarantees that each of the faces has a large enough extension. Using the resolution and the orientation of the photo frame the region of interest is determined and cropped/resized in the same way as is done for the faces separately.

The image is resized, step 207, to a target image size by determining the size and aspect ratio of the target image and determining the size and aspect ratio of the image. A scaling factor is then determined as

$$S = \frac{I}{T}$$

where S is the scaling factor; I is the determined size of the image; and T is the determined size of the target image. The image is then resized according to S.

In an embodiment, details of resizing a region of interest to fit a target image size are described below.

The size and aspect ratio of the target image size and the cropped region of interest is determined. These are compared to determine a scaling factor

$$S = \frac{R}{T}$$

where S is the scaling factor; R is the determined size of the region of interest and T is the determined size of the target image.

For the determined aspect ratio, a scaling factor S_{w} for the width and a scaling factor Sₕ for the height are determined as follows:

$${S}_{w} = \frac{{R}_{w}}{{T}_{w}}$$

$${S}_{h} = \frac{{R}_{h}}{{T}_{h}}$$

where R_{w} and Rₕ are the width and height of the region of interest, respectively, and T_{w} and Tₕ are the width and height of the target image, respectively.

If the aspect ratio of the region of interest and the target image size are different, S_{w} and Sₕ are different. If this occurs, use of either S_{w} or Sₕ will result in distortion of the resized region of interest. This is overcome by extending either Rₕ or R_{w} to make S_{w} and Sₕ the same and using this scaling factor to resize the region of interest.

This may be achieved by extending the region of interest to the desired Rₕ and R_{w}.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for providing an image for display, the method comprising the steps of:
determining at least one region of interest within an image;
resizing said image to a target image size;
if at least one region of interest is determined, cropping said image to each of said at least one region of interest;
resizing said cropped at least one region of interest to said target image size;
storing said resized image and said resized cropped at least one region of interest for display.

2. A method according to claim 1, wherein the step of resizing said image to a target image size comprises the steps of:
determining the size and aspect ratio of said target image;
determining the size and aspect ratio of said image;
determining a scaling factor from said determined size of said target image and size said determined size of said image; and
resizing said image according to said determined scaling factor.

3. A method according to claim 2, wherein the step of resizing said cropped at least one region of interest to said target image size comprises the steps of:
determining the size and aspect ratio of said cropped at least one region of interest;
determining a scaling factor from said determined size of said target image and said determined size of said cropped at least one region of interest; and
resizing said cropped at least one region of interest according to said determined scaling factor whilst maintaining said determined aspect ratio of said cropped at least one region of interest.

4. A method according to claim 3, wherein the step of resizing said cropped at least one region of interest according to said determined scaling factor whilst maintaining said determined aspect ratio comprises the steps of:
extending said cropped at least one region of interest to include at least a portion of said image outside of said cropped at least one region of interest such that the extended at least one region of interest has an aspect ratio corresponding to said determined aspect ratio of said image;
cropping said image to said extended at least one region of interest; and
resizing said cropped extended at least one region of interest to said target image size.

5. A method according to claim 1, wherein the method further comprises the step of:
selecting a stored, resized image of said image or said stored, resized cropped at least one region of interest of said image.

6. A method according to claim 5 further comprising the step of:
displaying said selected, stored image.

7. A method according to claim 1, wherein the step of determining at least one region of interest within an image comprises the step of:
automatically detecting at least one region of interest within an image.

8. A method according to claim 7, wherein the step of cropping said image to each of said at least one region of interest comprises the steps of:
extending said detected region of interest to include a portion of said image outside of said detected at least one region of interest;
cropping said image to said extended at least one region of interest.

9. A method according to claim 1, wherein the step of determining at least one region of interest within an image comprises the step of:
manually defining at least one region of interest within an image.

10. A computer program product comprising a plurality of program code portions for carrying out the method according to any claim 1.

11. Apparatus for providing an image for display, the apparatus comprising:
determining means for determining at least one region of interest within an image;
a processor for resizing said image to a target image size and, if at least one region of interest is determined, cropping said image to said at least one region of interest and resizing said cropped at least one region of interest to said target image size;
storage means for storing said resized image and said resized cropped at least one region of interest for display.

12. Apparatus according to claim 11 further comprising:
a display for displaying said stored image.

13. Apparatus according to claim 11, wherein said determining means includes a detector for automatically detecting at least one region of interest within an image.
